(19) United States
(12) Patent Application Publication
(10) Pub. No.: US 2006/0012153 A1
(43) Pub. Date: Jan. 19, 2006

(54) Airbag system for motor vehicle integrated in an inner trim piece

(75) Inventors: Matthias Arleth, Kleinostheim (DE); Werner Schmidt, Alzenau-Horstein (DE); Alex Martin, Aschaffenburg (DE); Uwe Speck, Aschaffenburg-Schwenheim (DE); Dirk Rubart, Bessenbach (DE)

Correspondence Address: HONIGMAN MILLER SCHWARTZ AND COHN LLP, 32270 TELEGRAPH RD, SUITE 225, BINGHAM FARMS, MI, 48025-2457, US

(73) Assignee: Acts Advanced Car Technology Systems GMBH & Co. KG

(21) Appl. No.: 11/233,707

(22) Filed: Sep. 23, 2005

Related U.S. Application Data
(62) Division of application No. 10/149,525, filed on Oct. 30, 2002.

(51) Int. Cl. B60R 21/20

(52) U.S. Cl. 280/728.3

(57) ABSTRACT

The invention relates to an airbag system for motor vehicles, integrated in an inner trim piece, in particular, in a dashboard (16), comprising an airbag (5, 5′, 5″), which is inflatable by means of a gas generator (8, 8′, 8″). The inner trim piece comprises at least one dimensionally stable support (1, 1′,k 1″) and an airbag cover (2, 2′, 2″), which opens outwards under the pressure of the airbag (5, 5′, 5″) filling with gas. The airbag cover (2, 2′, 2″) is flexible and designed to yield to the pressure of the filling airbag (5, 5′, 5″). The airbag (5, 5′, 5″) is arranged under the cover (2, 2′, 2″) in a housing (4, 4′, 4″), connected to the support (1, 1′, 1″).

### CROSS-NOTING TO RELATED APPLICATIONS

This application is a division application of application Ser. No. 10/149,525, filed Oct. 30, 2002, which is the National Stage of International Application No. PCT/EP00/12161, filed Dec. 8, 2000, the entire contents of which are herein incorporated by reference.

### BACKGROUND OF THE INVENTION

1. Field of the Invention

The invention relates to an airbag system which is integrated in an inner trim piece for motor vehicles, in particular a dashboard, and has an airbag which can be inflated by means of a gas generator, the inner trim piece comprising at least one dimensionally stable support and having an airbag cover which opens outward under the pressure of the filling airbag. The invention relates in particular to an inner trim piece having at least one region which is formed by tear lines and can be torn in a defined manner, in the airbag cover.

2. Description of Related Art

It is customary also to accommodate in the dashboard of the motor vehicle an airbag module for the front passenger. For this purpose, at least one flap which can be torn in the event of being triggered is provided in the dashboard. In the case of known designs of dashboards, said flaps comprise a dimensionally stable support made of plastic, wood fibers or metal, a covering layer or outer skin, in particular likewise made of plastic, if appropriate also made of leather, which forms the side facing the vehicle interior and is therefore designed as a decorative layer, and a foam layer via which the support and the covering layer or the outer skin are connected to each other. It is furthermore known to produce dashboards at least partly from laminates or from layers connected to one another by laminating. The airbag module, comprising the actual airbag and a gas generator, is, as a rule, supported below the support on the cross support of the motor vehicle. Tear lines, which are generally formed in the support as sections of weakened material--cuts or incisions--undertaken from the rear side of the support and with a linear profile and which can optionally also extend into the covering layer or outer skin or can even pass through the latter, predefine a flap with one or two wings which is burst open by the filling airbag. For this purpose, first of all a certain build up of pressure is required which finally leads to an explosion-like tearing of the flap or flaps. The hard flaps which open out in such a manner into the interior of the vehicle may constitute a not inconsiderable risk of injury for the front passenger, in particular if said front passenger happens to be “out of position” and therefore in relatively great proximity to the opening flaps and to the inflating airbag.

In order to reduce the risk of injury, it is proposed in DE-U 299 11 205 to use appropriate devices in that region of the airbag cover which is bounded in the support by the section of weakened cross section to remove, before the airbag is deployed, the material of the support and at least parts of the foam layer out of the region of effect of the airbag and to bring them behind the inner trim piece. For this purpose, a tension belt which is connected fixedly to the support is provided, which belt acts approximately perpendicularly with respect to the support and parallel to the section of weakened cross section and is connected to a tension device which can be triggered via a sensor. The tension belt can extend into the foam layer. A triggering sensor which acts together with the airbag or else separate pyrotechnic pressure generators can be provided for the tension device. This solution would therefore ensure that no parts of the material of the support pass into the passenger compartment of the vehicle, which would resolve some of the above-mentioned problems. This known solution would still be disadvantageous in that additional components to be coordinated in their function to the function of the airbag module and also requiring separate installation have to be provided. This is where translating it into practice would probably founder.

### SUMMARY OF THE INVENTION

The object of the invention is to develop an airbag system which ensures a “gentle” opening of the inner trim piece and a “gentle” triggering of the airbag, does not require such a great build up of pressure for opening the cover and makes it possible to position the airbag over a large area in the inner trim piece. It is to be achieved, in particular, that vehicle occupants which happen to be in an unfavorable position, accordingly are “out of position”, in an accident situation are at a clearly reduced risk of injury.

The object set is achieved according to the invention by the airbag cover being flexible and being designed to yield to the pressure of the filling airbag, and by the airbag being arranged below the cover in a receptacle connected to the support.

In this case, in order to achieve the object set, provision is made, in particular, for the airbag cover or the tearable region thereof to be designed to be flexible in such a manner that the airbag lifts up the cover or the tearable region, in particular with the formation of an outward bulge, and pulls it off along the tear lines.

The invention therefore takes an entirely new path in comparison with the solutions known to date. This is because it basically refrains from accommodating the airbag behind the support. A dimensionally stable, hard covering flap is therefore also dispensed with, which reduces the risk of injury for the occupants in the vehicle. The flexible airbag cover which yields under the pressure of the filling airbag can-be designed in such a manner that it opens even without tear lines in a manner which involves a significantly reduced risk of injury in comparison to known solutions. However, it is particularly advantageous if the tear lines are used to achieve a specific “pulling effect”, i.e. a particularly soft and gentle opening out of the cover and also a pulling away of the cover from the vehicle occupant. Particularly in this case possible injuries to a person who is “out of position” can be largely avoided.

The subclaims contain particularly advantageous refinements and developments of the invention.

It is particularly advantageous if an airbag system according to the invention is provided in the dashboard for the front passenger. In this case, the tearable region can namely be pulled off away from the front passenger and at least the first phase of the filling and deploying of the airbag can take place in a region which is as far away as possible from the front passenger. Both are measures which significantly reduce the risk of injury to the front passenger.

In this connection, the positioning of the airbag in the dashboard can also play a certain role, in which case it is particularly favorable if the airbag is accommodated in a manner spread out as far as possible.

The airbag itself is accommodated according to the invention below the cover in a receptacle which can be a part integrated in the support or a separate part connected to said support. The airbag can therefore be accommodated according to the invention directly below the cover and a shooting channel is no longer required.

In order to be able to accommodate the airbag in the folded or rolled state as optimally as possible in the receptacle, provision may be made to provide said receptacle with at least one depression.

According to the present invention, various options are available for the positioning of the gas generator. Thus, the gas generator can be accommodated within the support, in particular in the receptacle, for example in a recessed region thereof.

However, as an alternative to this, the gas generator can also be arranged outside the support, for example can be fastened from outside to the support or to the receptacle or else to another vehicle part. A multiplicity of options is open here enabling the respective structural circumstances of the vehicle to easily be taken into consideration.

In a further measure according to the invention, provision is made for the support and the receptacle for the airbag to be provided at least on the outside with reinforcing ribs or the like. A measure of this type can make a separate support of the gas generator, if the latter is accommodated in the support region or in the region of the receptacle for the airbag, unnecessary.

As far as the flexible design of the cover or the tearable region is concerned, there are also a number of options here. However, designs which can fit into the customary structure of inner trim pieces, in particular dashboards, or can easily be adapted to them, are encountered in particular. For example, in the case of possible design variants; provision is made for the cover or the tearable region thereof to comprise an outer layer, in particular of plastic, which is optionally provided on the inside with a foam layer, of a laminate or the like.

In the case of another possible design, the cover or the tearable region thereof can even be connected in a sheet-like manner to part of the airbag. This may be favorable, for example, for reasons to do with production, but, in particular because of the flexibility of the cover, does not affect the functioning of the airbag.

Particularly when the cover is made from a plastic outer skin with a foam layer, it is favorable, for reasons to do with production and for reasons of functionality, if the airbag which is positioned in the receptacle is covered on the outside with a separating layer, for example a film.

Precisely in the case of an airbag system which is designed and integrated according to the invention, it is possible, and also advantageous, if the airbag can be filled with gas not only at one, but also at a plurality of points. The inflation behavior of the airbag can be controlled as a result.

Provision is therefore also made for the airbag to be able to be filled with gas either by the gas generator directly or by means of a gas conduit or via a system of gas conduits and/or lines or else via a gas-distributing system.

For good coordination of the airbag positioned in the receptacle with the tearable region formed by tear lines, it is favorable if the tear lines in the cover at least partially and at least substantially follow the outer contour of the receptacle for the airbag. In this case, tear lines having a U-shaped profile are the preferred form especially for the case in which the airbag system according to the invention is accommodated in the dashboard for the front passenger.

### BRIEF DESCRIPTION OF THE DRAWINGS

Further features, advantages and details of the invention will be described in greater detail with reference to the drawing which illustrates a number of exemplary embodiments with reference to schematic illustrations. In the drawing

FIG. 1 shows a first embodiment of the invention, a cross section through a dashboard being illustrated in that region in which an airbag system for the front passenger is accommodated,

FIG. 2 shows, in a cross section similar to FIG. 1, a variant of the exemplary embodiment of the invention illustrated in FIG. 1,

FIG. 3 and FIG. 4 show further exemplary embodiments of the invention with reference to cross sections through dashboard regions,

FIG. 3a shows the embodiment from FIG. 3, likewise in cross section, directly after the airbag has been triggered, and

FIGS. 5a to 5d show various stages during the detachment of the outer cover by the filling airbag.

### DETAILED DESCRIPTION OF THE INVENTION

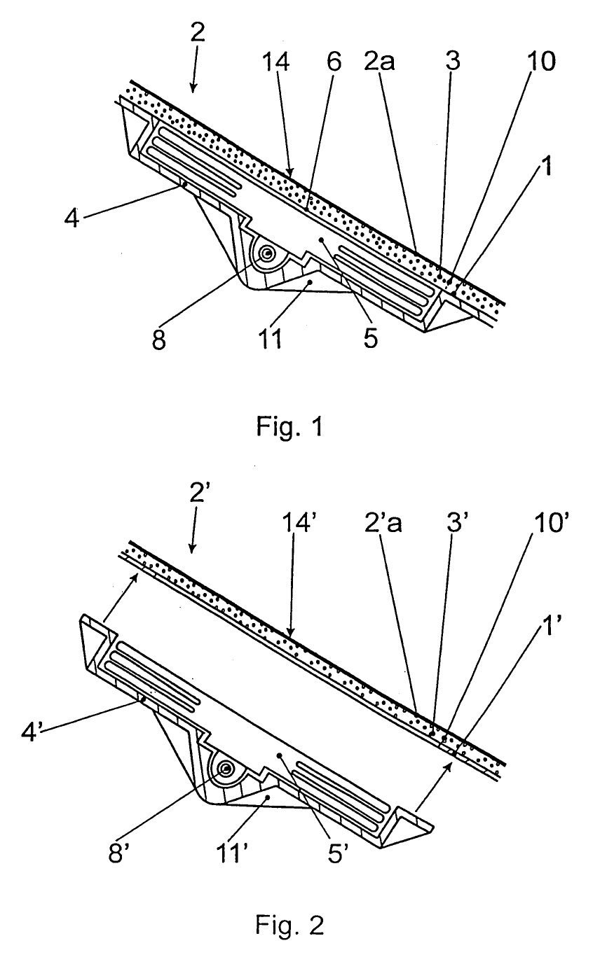

In these figures of the drawing, a dashboard is illustrated as an example of an inner trim piece. The dashboard illustrated has, as can be seen from FIGS. 1 to 4, a conventional, foamed construction with a support 1, 1′, 1″ forming its inside, a covering view 2a, 2′a, 2″a and a foam layer 3, 3′, 3″ situated in between. Outside that region in which an airbag system is accommodated in a manner still to be described, the support 1, 1′, 1″ and the covering layer 2a, 2′a, 2″a are connected to each other, in contact over a large area, via the foam layer 3, 3′, 3″.

In the case of dashboards constructed in such a manner, the support 1, 1′, 1″ is conventionally a dimensionally stable plastic part which is produced in particular by injection molding. The covering layer 2a, 2′a, 2″a consists of a more flexible plastic and is produced, for example, by a slush process, a spraying process or by deep-drawing. The covering layer 2a, 2′a, 2″a is therefore of softer design than the support 1, 1′, 1″ and has the outside which faces the passenger compartment and is generally of decorative design. The covering layer 2a, 2′a, 2″a can also consist of leather or of another material.

In the case of the embodiment according to FIG. 1, the support 1 is provided with a flat and trough-like receptacle 4 having a relatively large surface, for an airbag 5. In the region above the receptacle 4, the covering layer 2a forms together with the foam layer 3 the cover 2 for the airbag. In the case of the embodiment according to FIG. 1, the trough-shaped receptacle 4 is part of the support 1 and is a part which is formed together with the support 1 during the production thereof. The support 1 can be provided on the outside in the region of the receptacle 4 with reinforcing structures, for example with reinforcing ribs 11. The receptacle 4 can, as seen in plan view, be configured virtually as desired, in particular can be oval or approximately circular or rectangular, which is not apparent, however, from the drawing.

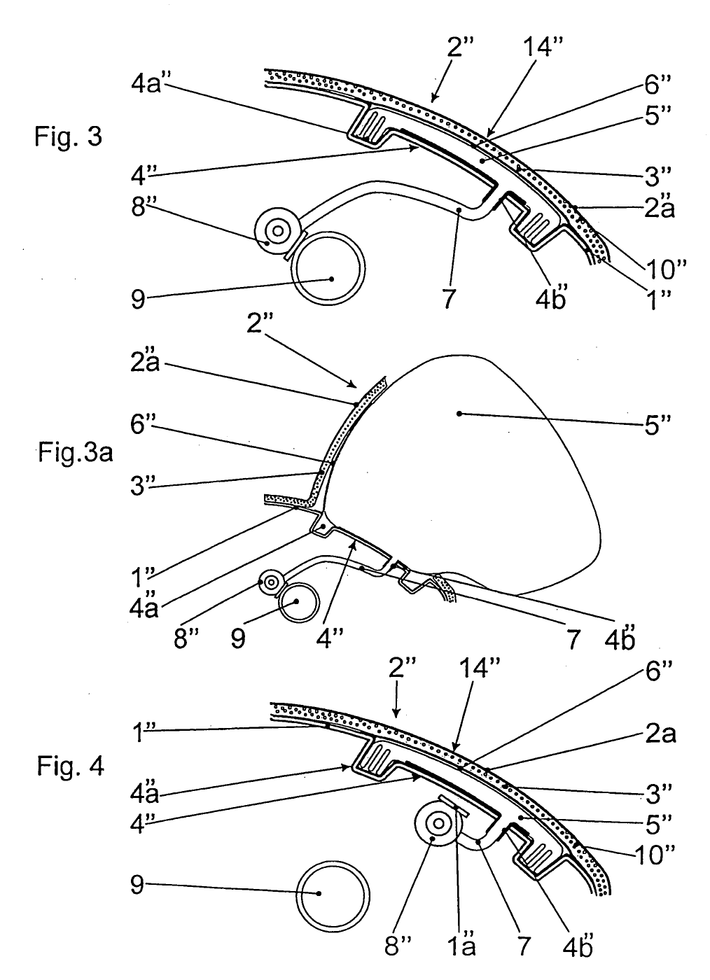

The airbag 5 which is inserted into the receptacle 4 is folded and is provided on the outside with a thin film 6, in particular of plastic, which covers the receptacle 4. Instead of a film, another manner of separating the airbag 5 from the foam layer 3 can be provided. The gas generator 8 is accommodated in a depression 4c of the receptacle 4, which depression is formed approximately centrally here. However, the gas generator 8 can also be arranged outside the receptacle 4, for example in a manner as is described further below with reference to the exemplary embodiments according to FIGS. 3 and 4. When the gas generator 8 is accommodated as illustrated, the filling of the airbag 5 with gas can take place without special lines, i.e. directly by the gas generator 8.

Tear lines 10 which define that region 14 which is opened by the airbag 5 in the event of being triggered are provided in the cover 2. The tear lines 10 are formed in particular by sections of weakened material which can be provided in the covering layer 2a and/or in the foam layer 3. In the event of the airbag 5 being triggered, the cover 2 therefore opens up in the region 14. The tear lines 10 may, for example, have a U-shaped profile, which is the case in the embodiments illustrated, in which case only the connecting section of the U can be seen in section, said connecting section running approximately along the lower edge region of the receptacle 4. The lateral limbs which run in particular along the side regions (not illustrated) of the receptacle 4 cannot be seen. The tear lines 10 may also take on other forms, for example round or oval, or can be designed as a simple line or in the form of an H. Tear lines 10 having a U-shaped profile form a single, defined tear region 14 in the cover 2. Tear lines having a H-shaped profile form two tear regions. U-shaped and H-shaped tear lines are preferably arranged in such a manner that when the dashboard is fitted the lateral limbs run perpendicularly with respect to the transverse direction of the vehicle, the intention being, in the case of a U shape, for the open ends of the limbs to point further away from the front passenger. The region or regions between the limb ends in which there are no tear lines form that region or those regions in which a connection to the remaining region of the cover 2 or to the inner trim piece is maintained when the airbag 5 is triggered and that region or those regions 14 of the cover 2 formed by the tear lines are detached. Additional structural measures may, but do not have to be, taken here in order for this connecting region or these connecting regions to undertake a hinge function. A hinge is preferably formed at the point at which the cover 2 is again connected to the support 1. The hinges or joints formed can be designed in a known manner and reinforcing materials, for example netting, fabric or films, can be introduced as a support for this function.

The support 1 can be produced together with the receptacle 4 by injection molding or in another process. In the finished support 1, the airbag module is placed into the receptacle 4, in particular with the airbag 5 already prefolded. The manner of folding the airbag 5 preferably takes place in such a way that the airbag 5 is inserted over a large area and, in particular, with unevennesses on its upper side being avoided. The receptacle 4 and with it the airbag 5 are then covered from the outside by the thin film 6 which is connected to the inside of the support 1 at the edge of the receptacle. For this purpose, the film 6 can be designed such that it is self-adhesive at its edge regions or can be glued separately to the support 1. The film 6 ensures the leak-tightness during the subsequent foaming process. The covering layer 2a and the support 1 are inserted into a foam mold and the space remaining between these components is filled with foam. The finished dashboard is removed from the mold and fitted in the vehicle in a customary manner.

The sections of weakened material forming the tear lines 10 can be formed in the cover 2 in such a manner that the covering layer 2a is produced locally in reduced thickness by the covering layer 2a being perforated or being cut into or through. The tear lines 10 can therefore be formed as early as during the production of the covering layer 2a by means of a web or similarly shaped article or can be produced subsequently in the finished covering layer 2a, for example by cutting by means of a knife or laser. In this case, the incisions can be made from the outside or from the inside and the foam layer 3 can be included at the same time or can be left unweakened.

In the case of the embodiment shown in FIG. 2, provision is made for the trough-shaped receptacle 4′, which is provided for receiving the airbag 5′, to form a part which is produced separately from the support 1′. This has the advantage that the receptacle 4′ can also consist of a different material than the support 1′, for example of a different plastic or of metal. The region above the receptacle 4′ forms a cover 2′ comprising the covering layer 2′a and the foam layer 3′. Also in the case of this embodiment, the gas generator 8′ can be accommodated in the receptacle 4′ in a depression 4′c.

The trough-shaped receptacle 4′ is fastened together with the inserted, folded airbag 5′ and the positioned gas generator 8′ to the lower side of the support 1′, for example is screwed thereto. This is indicated by the two arrows in FIG. 2. The connection can also take place by means of bonding, welding, by means of riveting or clips etc. In this design, reinforcing ribs 11′ or the like can also be provided on the outside of the receptacle 4′. The tear lines 10′ which are provided can be designed as described above with reference to FIG. 1.

If, in this design, the gas generator is arranged outside the receptacle 4′, it can be fastened, for example, to the lower side of the receptacle 4′ or to the cross support or to another suitable vehicle part. If required, a separate support of that component to which the gas generator is attached or in which it is accommodated can be undertaken, for example by means of supporting elements which connect this component to a vehicle part—the cross support or the like.

Depending on where the gas generator 8′ is positioned, in the case of this design gas may need to be supplied, it being possible for the supply to be undertaken, for example, in accordance with the exemplary embodiments described further below and shown in FIGS. 3 and 4.

In the case of one embodiment (not illustrated) of the invention, a separate gas-distributing box may be provided below the airbag in the receptacle, into which box the gas flows from the gas generator before it passes into the airbag. The intermediate bottom between the gas-distributing box and the receptacle is provided with continuous openings through which the gas flow flows into certain regions of the airbag.

In the case of the exemplary embodiment illustrated in FIG. 3, a receptacle 4″ is provided, which receptacle is integrated in the support 1 ″ and is provided in the edge region with groove-like depressions 4″a, which provides additional space for accommodating folds of the airbag 5″ Recessed regions can be provided at any desired points and in any desired form. Of course, special recesses for receiving airbag folds can also be omitted. In the case of this embodiment too, the airbag 5″ which is inserted into the receptacle 4″ is covered on the outside by a thin film 6, in particular made of plastic, which extends over the edges of the receptacle 4″. The airbag 5″ is connected to a gas generator 8′ arranged outside the support 1 via a gas conduit 7 shown here as a pipe. For this purpose, an opening 4″b is left free at a suitable point in the region of the receptacle 4″ in the support 1″. Instead of one opening 4″b, a plurality of openings for pipes or gas conduits branching off from the gas conduit 7 or for additional pipes or gas conduits can be arranged, which openings are provided in order to fill the airbag 5″ with gas in an optimum manner. The gas generator 8″ is fastened, for example, to that cross support 9 which produces the connection of the dashboard to the vehicle.

The embodiment illustrated in FIG. 4 corresponds to that according to FIG. 3 apart from the arrangement of the gas generator 8″. The gas generator 8″ is prefitted here on at least one part 1 ″a of the support 1″, in particular in the region of the lower side of the receptacle 4″. The part or parts 1″a can be formed at the same time during the production of the support 1″. When the dashboard is, fitted into the vehicle, the gas generator 8″ can additionally be connected to the cross support 9 via corresponding fastening parts, or can be fastened to said cross support. In this case, the airbag 5″, the gas generator 8″ and any supply or distributing pipes 7 to defined regions of the airbag 5 form a preassembled unit.

Tear lines 10″ which can be designed as described above are also provided in the case of the designs according to FIGS. 3 and 4.

FIG. 3a shows the airbag system from FIG. 3 with the airbag 5″ triggered and therefore filled, in which case it can also be seen that that region 14″ of the cover 2″ which is formed by the above-described, U-shaped tear lines 10″ has been opened.

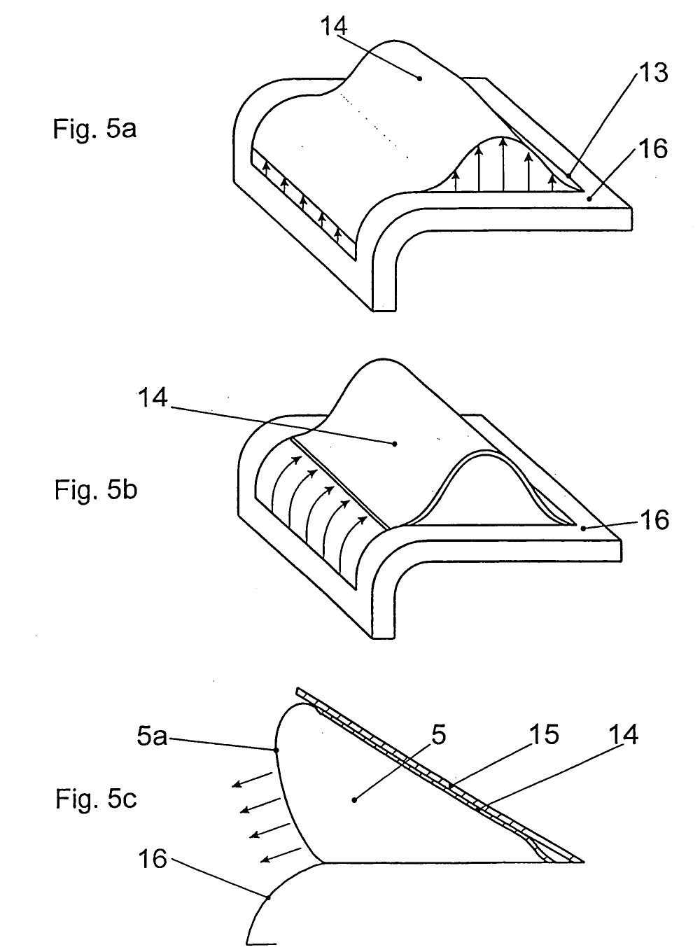

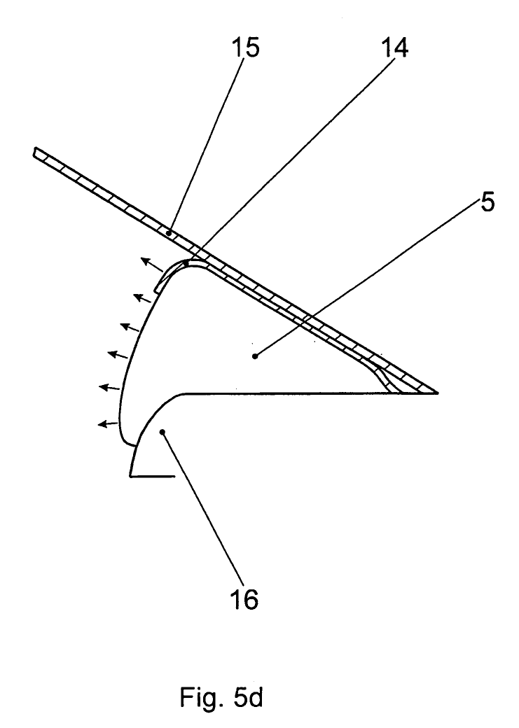

The opening and inflating behavior of an airbag system designed according to the invention will now be described by way of example with reference to FIGS. 5a to 5c. In these figures of the drawing, tear lines having a U-shaped profile are taken as the starting point. The connecting region 13 between the detaching region 14 and that part of the dashboard 16 which remains fixed in position is indicated by a line. This connecting region 13 is to be situated as far away as possible from the vehicle occupant, the front passenger. The airbag, which is not illustrated in FIGS. 5a and 5b, is preferably filled in such a manner that it inflates first of all in a region which lies as far away as possible from the vehicle occupant. As FIG. 5a shows, in an initial stage of the inflation or deployment, the flexible, detachable region 14 buckles or bulges outward from below, which takes place simultaneously with the region 14 being detached in the region of the sections of weakened material, in which case the region 14 is pulled away from the front-passenger's position. The arrows in FIG. 5a illustrate schematically the sequence of movement during this first phase.

FIG. 5b shows a further stage during the opening and detachment of the region 14. As mentioned, the region 14 is pulled away, as observed from the front-passenger's position, from the front passenger by the inflating and deploying airbag. The further growth of the airbag takes place with the formation of a comparatively even and extensive airbag wall in the direction of the front passenger. An extensive expansion of the folded airbag is advantageous for the desired “filling behavior” of the airbag. As FIG. 5c shows, the arrangement of the airbag system in the vehicle or on the dashboard can also have favorable effects. If, namely, the arrangement takes place in such a manner that the airbag system, and therefore in particular also the detaching region 14 thereof, is accommodated in the vicinity of the windshield 15, then the windshield 15, against which the region 14 finally comes to rest, supports the desired growth by encouraging the formation of an airbag wall in the direction of the front passenger. The group of arrows in FIG. 5c clarifies the “airbag wall” which is to be moved toward the vehicle occupant.

FIG. 5d shows a variant of the phase shown in FIG. 5c of the triggering and inflation of the airbag 5. In the case of this variant, it is also positioned with a large volume above the downwardly pointing region of the dashboard 16. The group of arrows clarifies the “airbag wall” which arises.

It turns out that in order to trigger the airbag of an airbag system according to the invention less energy is required than in the case of conventional airbag modules. The inflation behavior which is outlined and the “pulling effect” which is described are, as mentioned above, assisted by the airbag being inflated in a position as far away as possible from the occupant. Injuries to a vehicle occupant who is “out of position” in an accident situation, for example if in a hunched forward position, can be avoided especially by the preferred inflation behavior outlined and the “pulling effect”.

The invention is not restricted to the embodiments which have been illustrated and described. Thus, for example, it is possible to omit a section of weakened material in order to form a defined, detachable region. The inflation behavior of the airbag can be adjusted in such a manner that the soft, flexible and also comparatively thin cover tears above the airbag even without sections of weakened material. The risk of injury is also reduced in this case, since there are no hard parts which might strike against a vehicle occupant. It is furthermore also possible to form the outer cover and the detachable region merely from a soft and flexible outer skin made of plastic, without a foam layer. However, instead of a foam layer one of more nonwoven fabric layers or layers of other materials may also be provided. Furthermore, the airbag may be accommodated in an at least partially rolled form in the trough-shaped receptacle. Separate depressions for accommodating airbag parts in the trough-shaped receptacle can be entirely omitted or such depressions can be provided at any desired points and in any desired form.

1. An airbag system for integrating into an internal trim part for a vehicle, comprising:
an airbag capable of being inflated by means of a gas generator;
wherein said interior trim part comprises:
a covering layer; and
a support layer for supporting said covering layer, a portion of said support layer defining a receptacle for said airbag, said receptacle including at least one depression for receiving at least one fold of said airbag.

2. The airbag system according to claim 1, wherein said at least one depression is formed about a perimeter of said receptacle.

3. The airbag system according to claim 1, further comprising an intermediate layer disposed between said support layer and said covering layer.

4. The airbag system according to claim 3, wherein said intermediate layer comprises foam material.

5. The airbag system according to claim 3, further comprising a layer of film disposed between said intermediate layer and said receptacle.

6. The airbag system according to claim 1, wherein said covering layer includes at least one region defined by tear lines.

7. The airbag system according to claim 6, wherein at least a portion of said tear lines in said covering layer follow an outer contour of said receptacle for said airbag.

8. The airbag system according to claim 6, wherein at least a portion of said tear lines have a U-shaped profile.
